(19) United States
(12) Patent Application Publication
(10) Pub. No.: US 2015/0009212 A1
(43) Pub. Date: Jan. 8, 2015

(54) CLOUD-BASED DATA PROCESSING

(71) Applicants: Kar-Han Tan, Sunnyvale, CA (US); John Apostolopoulos, Palo Alto, CA (US)

(72) Inventors: Kar-Han Tan, Sunnyvale, CA (US); John Apostolopoulos, Palo Alto, CA (US)

(21) Appl. No.: 14/378,828

(22) PCT Filed: Mar. 22, 2012
(86) PCT No.: PCT/US2012/030184

§ 371 Date: Aug. 14, 2014

(51) Int. Cl. H04L 29/06; G06T 15/00

(52) U.S. Cl. CPC H04L 65/607; H04L 65/601; G06T 15/00
USPC 345/419; 709/231

(57) ABSTRACT

Cloud-based data processing. Input data is captured at a data acquisition device. The input data is streamed to a cloud server communicatively coupled to the data acquisition device over a network connection, in which at least a portion of the streaming of the input data occurs concurrent to the capturing of the input data, and in which the cloud server is configured for performing data processing on the input data to generate processed data. The data acquisition device receives the processed data, in which at least a portion of the receiving of the processed data occurs concurrent to the streaming of the input data.

### BACKGROUND

Mobile devices, such as smart phones or tablets, are becoming increasingly available to the public. Mobile devices comprise numerous computing functionalities, such as email readers, web browsers, and media players. However, due in part to the desire to maintain a small form factor, typical smart phones still have lower processing capabilities than larger computer systems, such as desktop computers or laptop computers.

### BRIEF DESCRIPTION OF THE DRAWINGS

The accompanying drawings, which are incorporated in and form a part of this specification, illustrate and serve to explain the principles of embodiments in conjunction with the description. Unless specifically noted, the drawings referred to in this description should be understood as not being drawn to scale.

FIG. 1 shows an example system upon which embodiments of the present invention may be implemented.

FIG. 2 shows an example of a device acquiring data in accordance with embodiments of the present invention.

FIG. 3 is a block diagram of an example system used in accordance with one embodiment of the present invention.

FIG. 4A is example flowchart for cloud-based data processing in accordance with embodiments of the present invention.

FIG. 4B is an example time table for cloud-based data processing in accordance with embodiments of the present invention.

FIG. 5 is an example flowchart for rendering a three-dimensional object in accordance with embodiments of the present invention.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. Furthermore, in the following description, numerous specific details are set forth in order to provide a thorough understanding of the subject matter. In other instances, well-known methods, procedures, objects, and circuits have not been described in detail as not to unnecessarily obscure aspects of the subject matter.

### Notation and Nomenclature

Some portions of the description of embodiments which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present discussions terms such as “capturing”, “streaming”, “receiving”, “performing”, “extracting”, “coordinating”, “storing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Furthermore, in some embodiments, methods described herein can be carried out by a computer-usable storage medium having instructions embodied therein that when executed cause a computer system to perform the methods described herein.

### Overview of Discussion

Example techniques, devices, systems, and methods for implementing cloud-based data processing are described herein. Discussion begins with an example data acquisition device and cloud-based system architecture. Discussion continues with examples of quality indication. Next, example three dimensional (3D) object capturing techniques are described. Discussion continues with an example electronic environment. Lastly, two example methods of use are discussed.

### Example Data Acquisition and Cloud-Based System Architecture

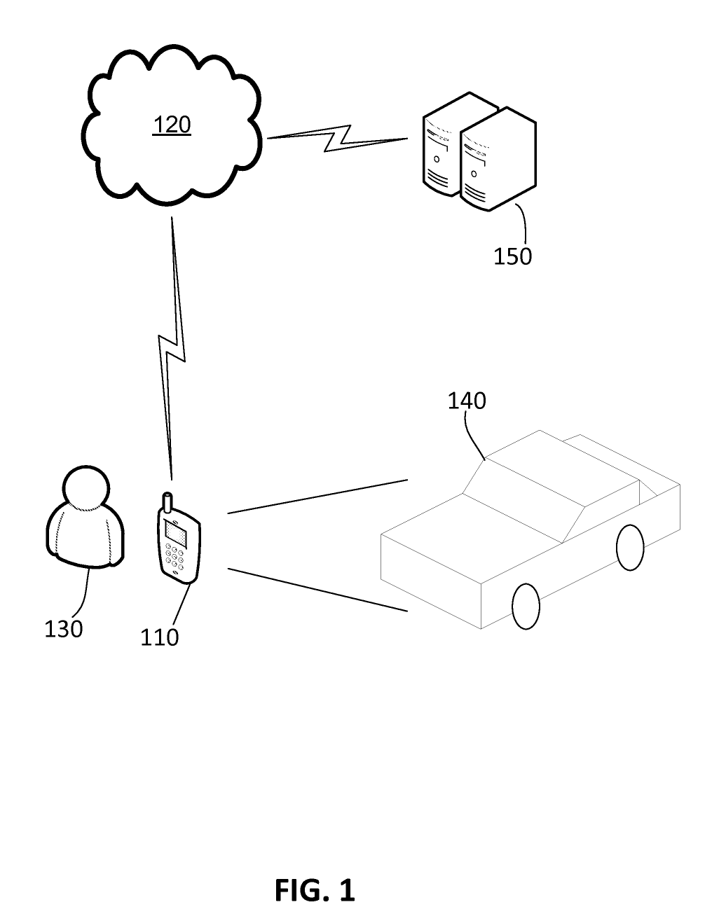

FIG. 1 shows data acquisition device 110 capturing data and streaming that data to cloud server 150. It should be understood that although the example illustrated in FIG. 1 shows a hand-held data acquisition device 110 capturing depth data, data acquisition device 110 can capture other types of data including, but not limited to: image, audio, video, 3D depth maps, velocity, acceleration, ambient light, location/position, motion, force, electro-magnetic waves, light, vibration, radiation, etc. Further, data acquisition device 110 could be any type of electronic device including, but not limited to: a smart phone, a personal digital assistant, a plenoptic camera, a tablet computer, a laptop computer, a digital video recorder, etc.

After capturing input data, data acquisition device 110 streams input data through network 120 to cloud server 150. Typically, applications configured for use with cloud computing are transaction based. For example, a request to process a set of data is sent to the cloud. After the data upload to the cloud is completed processing is performed on all the data. When processing of all the data completes, all data generated by the processing operation is sent back. Typically in a transaction-based approach the steps in the transaction occur sequentially, which results in large time delays between the beginning and end of each transaction, making it challenging to support real time interactive applications with cloud services. FIG. 1 illustrates a device configured for continuous live streaming applications, where the round trip delay to cloud server 150 has a low latency, and occurs concurrent to capturing and processing data. For example, as opposed to transaction based cloud computing, in one embodiment data acquisition device 110 concurrently captures data, streams the data to cloud server 150 for processing, and receives the processed data. In one example, depth data is captured and streamed to cloud server 150. In one embodiment, cloud server 150 provides feedback to data acquisition device 110 in order to enable user 130 to capture higher quality data, or to capture data quicker or finish the desired task quicker.

In one embodiment, data acquisition device 110 sends input data to cloud server 150 which performs various operations on the input data. For example, cloud server 150 is operable to determine what type of input is received, perform intensive computations on data, and sends processed data back to data acquisition device 110.

FIG. 1 illustrates a continuous stream of input data being sent to cloud server 150. Data acquisition device 110 continuously captures and sends data to cloud server 150 as cloud server 150 performs operations on input data and sends data back to data acquisition device 110. In one embodiment, capturing data at data acquisition device 110, sending data to cloud server 150, processing data, and sending data from cloud server 150 back to data acquisition device 110 are performed simultaneously. For example, these operations may all start and stop at the same time, however, these operations do not need to start and stop at the same time. In some embodiments, data acquisition device 110 may begin acquiring data prior to sending the data to cloud server 150. In some embodiments, cloud server 150 may perform operations on data and/or send data to data acquisition device 110 after data acquisition device 110 has finished capturing data. Although the operations described herein may start and stop at the same time, they may also overlap. For example, data acquisition device 110 may stop streaming data to cloud server 150 before cloud server 150 stops streaming processed data to data acquisition device 110. Moreover, in some examples, data acquisition device 110 may capture data and then stream the captured data to cloud server 150 while simultaneously continuing to capture new data.

In addition to processing data on cloud server 150, data acquisition device 110 may perform a portion of the data processing itself prior to streaming input data. For example, rather than sending raw data to cloud server 150, data acquisition device 110 may perform a de-noising operation on the depth and/or image data before the data is sent to cloud server 150. In one example, depth quality is computed on data acquisition device 110 and streamed to cloud server 150. In one embodiment, data acquisition device 110 may indicate to user 130 (e.g., via meta data) whether a high quality image was captured prior to streaming data to cloud server 150. In another embodiment, data acquisition device 110 may perform a partial or complete feature extraction before sending the partial or complete features to the cloud server 150.

In one embodiment, data acquisition device 110 may not capture enough data for a particular operation. In that case, data acquisition device 110 captures additional input data and streams the additional data to cloud server 150 such that cloud server 150 reprocesses the initial input data along with the additional input data to generate higher quality reprocessed data. After reprocessing the data cloud server 150 streams the reprocessed data back to data acquisition device 110.

### Example Quality Indication System

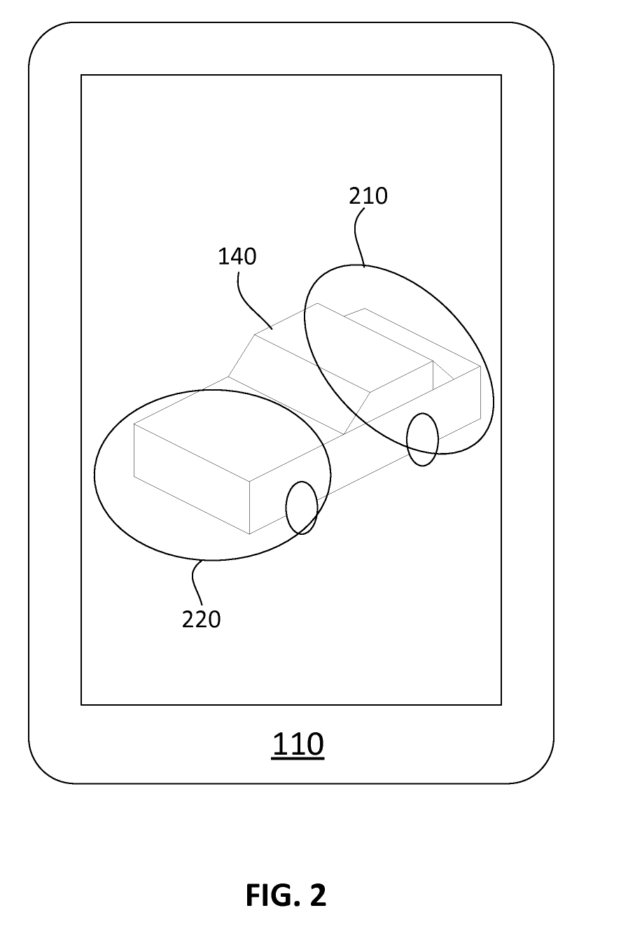

FIG. 2 shows an example data acquisition device 110 that, in one embodiment, provides a user 130 with meta data, which may include a quality indicator of the processed data. In one embodiment, as data acquisition device 110 receives processed data from cloud server 150, data acquisition device 110 indicates to user 130 the quality of the processed data and whether cloud server 150 could use additional data in order to increase the quality of the processed data. For example, while data acquisition device 110 is capturing data, and simultaneously sending and receiving data, a user interface may display areas where additional input data could be captured in order to increase the quality of processed data. For example, when capturing a three-dimensional (3D) model, a user interface may show user 130 where captured data is of high quality, and where captured data is of low quality thus requiring additional data. This indication of quality may be displayed in many ways. In some embodiments, different colors may be used to show a high quality area 220 and a low quality area 210 (e.g., green for high quality and red for low quality). Similar indicators may be used when data acquisition device 110 is configured for capturing audio, velocity, acceleration, etc.

For example, in various embodiments, cloud server 150 may identify that additional data is needed, identify where the needed additional data is located, and communicate that additional data is needed and where the needed additional data is located to user 130 in an easy to understand manner which guides user 130 to gather the additional information. For example, after identifying that more data is required, cloud server 150 identifies where more data is required, and then sends this information to user 130 via data acquisition device 110.

For example, still referring to FIG. 2, data acquisition device 110 may have captured area 220 with a high level of certainty as to whether the captured data is of sufficient quality, while data acquisition device 110 captured area 210 with a low degree of certainty. In a high quality area 220, data acquisition device 110 indicates that it has captured input data with a particular level of certainty or quality. In one embodiment, data acquisition device 110 will shade high quality area 220 green and shade low quality area 210 red. For example, if a voxel representation is used for visualizing three-dimensional points, each voxel is colored according to the maximum uncertainty of three-dimensional points the voxel contains. This allows user 130 to incrementally build the 3D model, guided by feedback received from cloud server 150. To put it another way, user 130 will know that additional input data should, or in some cases must, be gathered for low quality area 210 in order to capture reliable input data. It should be noted that shading areas of high and low quality are only examples of how data acquisition device 110 uses meta data in order to provide quality indicators. In other embodiments, low quality area 210 may be highlighted, encircled, or have symbols overlapping low quality area 210 to indicate low quality. In one embodiment similar techniques are used for indicating the quality of high quality area 220.

As an example, to gather additional input data, user 130 may walk to the opposite side of object 140 to gather higher quality input data for low quality area 210. While the user is walking, the data acquisition device can be showing the user the current state of the captured 3D model with indications of the level of quality at each part, and which part of the model the user is currently capturing. In one embodiment user 130 can indicate to data acquisition device 110 that he is capturing additional data in order to increase the quality of data for low quality area 210. As some examples, user 130 can advise data acquisition device 110 that he is capturing additional data to supplement a low quality area 210 by tapping on the display screen near low quality area 210, clicking on low quality area 210 with a cursor, or by a voice command. In one embodiment, data acquisition device 110 relays the indication made by user 130 to cloud server 150.

In one embodiment, cloud server 150 streams feedback data to a device other than data acquisition device 110. For example, cloud server 150 may stream data to a display at a remote location. If data acquisition device 110 is capturing data in an area with low visibility where user 130 cannot see or hear quality indicators, a third party may receive feedback information and relay the information to user 130. For example, if user 130 is capturing data under water, or in a thick fog, a third party may communicate to user 130 what areas need additional input data. In one embodiment, cloud server 150 streams data to both data acquisition device 110 and to at least one remote location where third parties may view the data being captured using devices other than data acquisition device 110. The quality of the data being captured may also be shown on devices other than data acquisition device 110. In one embodiment, GPS information may be used to advise user 130 on where to move in order to capture more reliable data. The GPS information may be used in conjunction with cloud server 150.

As discussed above, the input data captured by data acquisition device 110 is not necessarily depth or image data. It should be understood that characteristics, as used herein, are synonymous with components, modules, and/or devices. Data acquisition device 110 may include characteristics including, but not limited to: a video camera, a microphone, an accelerometer, a barometer, a 3D depth camera, a laser scanner, a Geiger counter, a fluidic analyzer, a global positioning system, a global navigation satellite system receiver, a lab-on-a-chip device, etc. Furthermore, in one embodiment, the amount of data captured by data acquisition device 110 may depend on the characteristics of data acquisition device 110 including, but not limited to: battery power, bandwidth, computational power, memory, etc. In one embodiment data acquisition device 110 decides how much processing to perform prior to streaming data to cloud server 150 based in part on the characteristics of data acquisition device 110. For example, the amount of compression applied to the captured data can be increased if the available bandwidth is small.

In one embodiment, at least a second data acquisition device 110 may capture data to stream to cloud server 150. In one embodiment, cloud server 150 combines data from multiple data acquisition devices 110 before streaming combined, processed data to data acquisition device(s) 110. In one embodiment, cloud server 150 automatically identifies that the multiple data acquisition devices 110 are capturing the same object 140. The data acquisition devices 110 could be 5 meters apart, 10 meters apart, or over a mile apart. Data acquisition devices 110 can capture many types of objects 140 including, but not limited to: a jungle gym, a hill or mountain, the interior of a building, commercial construction components, aerospace components, etc. It should be understood that this is a very short list of examples of objects 140 that data acquisition device 110 may capture. As discussed herein, in one example, by creating a three-dimensional rendering using the mobile device, resources are saved by not requiring user 130 to bring object 140 into a lab because user 130 can simply forward a three-dimensional model of object 140 captured by data acquisition device 110 to a remote location to save as on a computer, or to print with a three-dimensional printer.

### Example Three-Dimensional Object Capturing Techniques

Still referring to FIG. 2, data acquisition device 110 may be used for three-dimensional capturing of object 140. In one embodiment, data acquisition device may merely capture data, while some or all of the processing is performed in cloud server 150. In one embodiment, data acquisition device 110 captures image/video data and depth data. In one example, data acquisition device 110 captures depth data alone. Capturing a three-dimensional image with data acquisition device 110 is very advantageous since many current three-dimensional image capturing devices are cumbersome and rarely hand-held. For example, after capturing a three-dimensional object 140, user 130 may send the rendering to a three-dimensional printer at their home or elsewhere. Similarly, user 130 may send the file to a remote computer to save as a computer aided design file, for example.

Data acquisition device 110 may employ an analog-to-digital converter to produce a raw, digital data stream. In one embodiment data acquisition device 110 employs composite video. Also, a color space converter may be employed by data acquisition device 110 or cloud server 150 to generate data in conformance with a particular color space standard including, but not limited to the red, green, blue color model (RGB) and the Luminance, Chroma: Blue, Chroma: Red family of color spaces (YCbCr).

In addition to capturing video, in one embodiment data acquisition device 110 captures depth data. Leading depth sensing technologies include structured light, per-pixel time-of-flight, and iterative closest point (ICP). In some embodiments of some of these techniques, much or all of the processing may be performed at data acquisition device 110. In other embodiments, portions of some of these techniques may be performed at cloud server 150. Still in other embodiments, some of these techniques may be performed entirely at cloud server 150.

In one embodiment, data acquisition device 110 may use the structured light technique for sensing depth. Structured light, as used in the Kinect™ by PrimeSense™, captures a depth map by projecting a fixed pattern of spots with infrared (IR) light. An infrared camera captures the scene illuminated with the dot pattern and depth can be estimated based on the amount of displacement. In some embodiments, this estimation may be performed on cloud server 150. Since the PrimeSense™ sensor requires a baseline distance between the light source and the camera, there is a minimum distance that objects 140 need to be in relation to data acquisition device 110. In structured light depth sensing, as the scene point distance increases, the depth sensor measuring distances by triangulation becomes less precise and more susceptible to noise. Per-pixel time-of-flight sensors do not use triangulation, but instead rely on measuring the intensity of returning light.

In another embodiment, data acquisition device 110 uses per-pixel time-of-flight depth sensors. Per-pixel time-of-flight depth sensors also use infrared light sources, but instead of using spatial light patterns they send out temporally modulated IR light and measure the phase shift of the returning light signal. The Canesta™ and MESA™ sensors employ custom CMOS/CCD sensors while the 3DV ZCam™ employs a conventional image sensor with a gallium arsenide-based shutter. As the IR light sources can be placed close to the IR camera, these time-of-flight sensors are capable of measuring shorter distances.

In another embodiment, data acquisition device 110 employs the Iterative Closest Point technique. As ICP is computationally intensive, in one embodiment it is performed on cloud server 150. ICP also aligns partially overlapping 3D points. Often it is desirable to piece together, or register depth data captured from a number of different positions. For example, to measure all sides of a cube, at least two depth maps captured from front and back are necessary. At each step the ICP technique finds correspondence between a pair of 3D point clouds and computes the rigid transformation which best aligns the point clouds.

In one embodiment, stereo video cameras may be used to capture data. Images and stereo matching techniques such as plane sweep can be used to recover 3D depth based on finding dense correspondence between pairs of video frames. As stereo matching is computationally intensive, in one embodiment it is performed on cloud server 150.

The quality of raw depth data capture is influenced by factors including, but not limited to: sensor distance to the capture subject, sensor motion, and infrared signal strength.

Relative motion between the sensor and the scene can degrade depth measurements. In the case of structured light sensors, observations of the light spots may become blurred, making detection difficult and also making localization less precise. In the case of time-of-flight sensors, motion violates the assumption that each pixel is measuring a single scene point distance.

In addition to light fall off with distance, different parts of the scene may reflect varying amounts of light that the sensors need to capture. If object 140 absorbs and does not reflect light, it becomes challenging for structured light sensors to observe the light spots. For time-of-flight sensors, the diminished intensity reduces the precision of the sensor.

As discussed above, because some embodiments are computationally intensive, a data acquisition device 110 may include a graphics processing unit (GPU) to perform some operations prior to streaming input data to cloud server 150, thereby reducing computation time. In one embodiment, data acquisition device 110 extracts depth information from input data and/or a data image prior to streaming input data to cloud server 150. In one example, both image data and depth data are streamed to cloud server 150. It should be understood that data acquisition device 110 may include other processing units including, but not limited to: a visual processing unit and a central processing unit.

### Example Electronic Environment

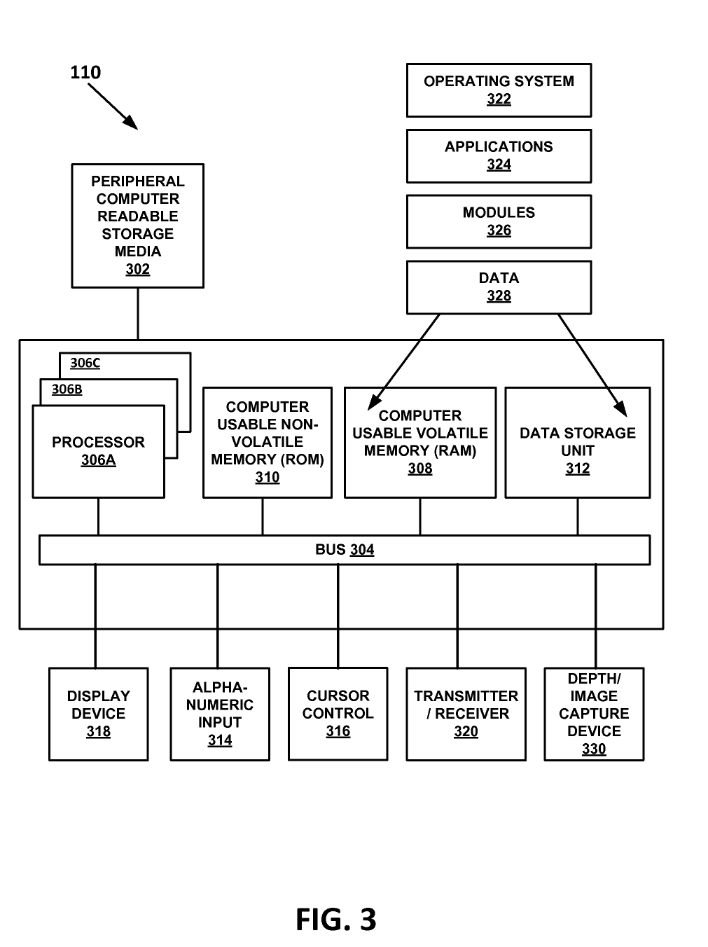

With reference now to FIG. 3, all or portions of some embodiments described herein are composed of computer-readable and computer-executable instructions that reside, for example, in computer-usable/computer-readable storage media of data acquisition device 110. That is, FIG. 3 illustrates one example of a type of data acquisition device 110 that can be used in accordance with or to implement various embodiments which are discussed herein. It is appreciated that data acquisition device 110 as shown in FIG. 3 is only an example and that embodiments as described herein can operate in conjunction with a number of different computer systems including, but not limited to: general purpose networked computer systems, embedded computer systems, routers, switches, server devices, client devices, various intermediate devices/nodes, stand alone computer systems, media centers, handheld computer systems, multi-media devices, and the like. Data acquisition device 110 is well adapted to having peripheral tangible computer-readable storage media 302 such as, for example, a floppy disk, a compact disk, digital versatile disk, other disk based storage, universal serial bus “thumb” drive, removable memory card, and the like coupled thereto. The tangible computer-readable storage media is non-transitory in nature.

Data acquisition device 110, in one embodiment, includes an address/data bus 304 for communicating information, and a processor 306A coupled with bus 304 for processing information and instructions. As depicted in FIG. 3, data acquisition device 110 is also well suited to a multi-processor environment in which a plurality of processors 306A, 306B, and 306C are present. Conversely, data acquisition device 110 is also well suited to having a single processor such as, for example, processor 306A. Processors 306A, 306B, and 306C may be any of various types of microprocessors. Data acquisition device 110 also includes data storage features such as a computer usable volatile memory 308, e.g., random access memory (RAM), coupled with bus 304 for storing information and instructions for processors 306A, 306B, and 306C. Data acquisition device 110 also includes computer usable non-volatile memory 310, e.g., read only memory (ROM), coupled with bus 304 for storing static information and instructions for processors 306A, 306B, and 306C. Also present in data acquisition device 110 is a data storage unit 312 (e.g., a magnetic or optical disk and disk drive) coupled with bus 304 for storing information and instructions. Data acquisition device 110 may also include an alphanumeric input device 314 including alphanumeric and function keys coupled with bus 304 for communicating information and command selections to processor 306A or processors 306A, 306B, and 306C. Data acquisition device 110 may also include a cursor control device 316 coupled with bus 304 for communicating user 130 input information and command selections to processor 306A or processors 306A, 306B, and 306C. In one embodiment, data acquisition device 110 may also include a display device 318 coupled with bus 304 for displaying information.

Referring still to FIG. 3, in one embodiment display device 318 of FIG. 3 may be a liquid crystal device, light emitting diode device, cathode ray tube, plasma display device or other display device suitable for creating graphic images and alphanumeric characters recognizable to user 130. In one embodiment, cursor control device 316 allows user 130 to dynamically signal the movement of a visible symbol (cursor) on a display screen of display device 318 and indicate user 130 selections of selectable items displayed on display device 318. Many implementations of cursor control service 316 are known in the art including a trackball, mouse, touch pad, joystick or special keys on alphanumeric input device 314 capable of signaling movement of a given direction or manner of displacement. Alternatively, it will be appreciated that a cursor can be directed and/or activated via input from alphanumeric input device 314 using special keys and key sequence commands. Data acquisition device 110 is also well suited to having a cursor directed by other means such as, for example, voice commands. Data acquisition device 110 also includes a transmitter/receiver 320 for coupling data acquisition device 110 with external entities such as cloud server 150. For example, in one embodiment, transmitter/receiver 320 is a wireless card or chip for enabling wireless communications between data acquisition device 110 and network 120 and/or cloud server 150. As discussed herein, data acquisition device 110 may include other input/output devices not shown in FIG. 3. For example, in one embodiment data acquisition device includes a microphone. In one embodiment, data acquisition device 110 includes a depth/image capture device 330 used for capturing depth data and/or image data.

Referring still to FIG. 3, various other components are depicted for data acquisition device 110. Specifically, when present, an operating system 322, applications 324, modules 326, and data 328 are shown as typically residing in one or some combination of computer usable volatile memory 308 (e.g., RAM), computer usable non-volatile memory 310 (e.g., ROM), and data storage unit 312. In some embodiments, all or portions of various embodiments described herein are stored, for example, as an application 324 and/or module 326 in memory locations within RAM 308, computer-readable storage media within data storage unit 312, peripheral computer-readable storage media 302, and/or other tangible computer-readable storage media.

### Example Methods of Use

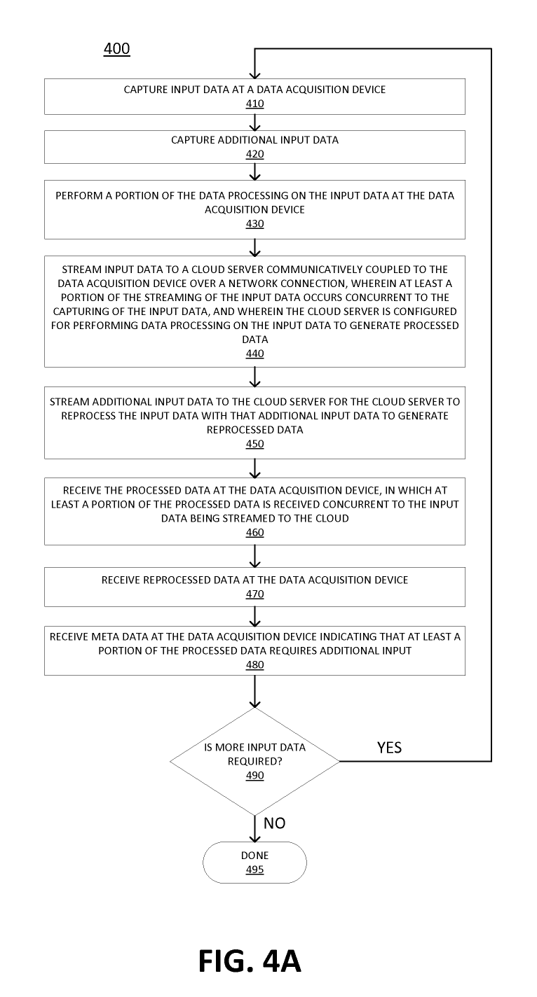

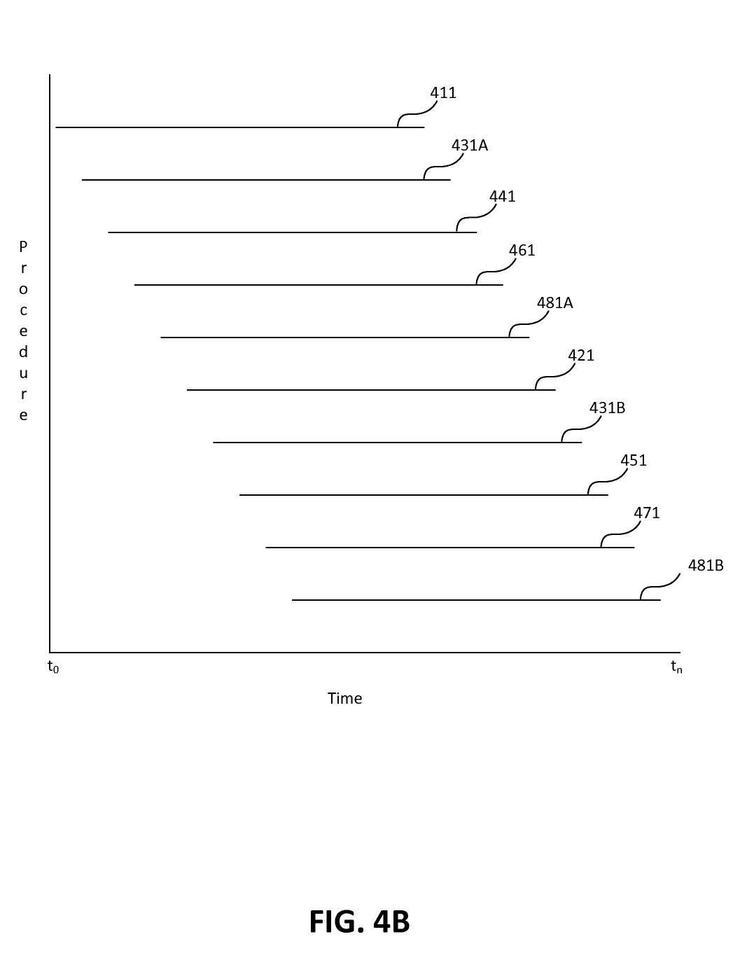

The following discussion sets forth in detail the operation of some example methods of operation of embodiments. FIG. 4A illustrates example procedures used by various embodiments. Flow diagram 400 includes some procedures that, in various embodiments, are carried out by one or more of the electronic devices illustrated in FIG. 1, FIG. 2, FIG. 3, or a processor under the control of computer-readable and computer-executable instructions. In this fashion, procedures described herein and in conjunction with flow diagram 400 are or may be implemented using a computer, in various embodiments. The computer-readable and computer-executable instructions can reside in any tangible computer readable storage media, such as, for example, in data storage features such as RAM 308, ROM 310, and/or storage device 312 (all of FIG. 3). The computer-readable and computer-executable instructions, which reside on tangible computer readable storage media, are used to control or operate in conjunction with, for example, one or some combination of processor 306A, or other similar processor(s) 306B and 306C. Although specific procedures are disclosed in flow diagram 400, such procedures are examples. That is, embodiments are well suited to performing various other procedures or variations of the procedures recited in flow diagram 400. Likewise, in some embodiments, the procedures in flow diagram 400 may be performed in an order different than presented and/or not all of the procedures described in one or more of these flow diagrams may be performed, and/or one or more additional operations may be added. It is further appreciated that procedures described in flow diagram 400 may be implemented in hardware, or a combination of hardware, with either or both of firmware and software.

FIG. 4A is a flow diagram 400 of an example method of processing data in a cloud-based server.

FIG. 4B is an example time table demonstrating the time at which various procedures described in FIG. 4A may be performed. Like flow diagram 400, FIG. 4B is an example. That is, embodiments are well suited for performing various other procedures or variations of the procedures shown in FIGS. 4A and 4B. Likewise, in some embodiments, the procedures in time table 4B may be performed in an order different than presented and/or not all of the procedures described may be performed, and/or additional procedures may be added. Note that in some embodiments the procedures described herein may overlap with each other given the nature of continuous live streaming embodiments described throughout the instant disclosure. As an example, data acquisition device 110 may be acquiring initial input data at line 411 while concurrently: (1) streaming data to cloud server 150 at line 441; (2) receiving data from said cloud server at line 461; (3) indicating that at least a portion of the processed data requires additional input at line 481; and (4) capturing additional input data at line 421.

In operation 410, data acquisition device 110 captures input data. In one example, data acquisition device 110 is configured for capturing depth data. In another example, data acquisition device 110 is configured for capturing image and depth data. In some embodiments, data acquisition device 110 is configured for capturing other types of input data including, but not limited to: sound, light, motion, vibration, etc. In some embodiments, operation 410 is performed before any other operation as shown by line 411 of FIG. 4B as an example.

In operation 420, in one embodiment, data acquisition device 110 captures additional input data. If cloud server 150 or data acquisition device 110 indicates that the data captured is unreliable, uncertain, or that more data is needed, then data acquisition device 110 may be used to capture additional data to create more reliable data. For example, in the case of a capturing a three-dimensional object 140, data acquisition device 110 may continuously capture data, and when user 130 is notified that portions of captured data are not sufficiently reliable, user 130 may move data acquisition device 110 closer to low quality area 210. In some embodiments, operation 420 is performed after data acquisition device 110 indicates to user 130 that additional input data is required in operation 480, as shown by line 421 of FIG. 4B as an example.

In operation 430, in one embodiment, data acquisition device 110 performs a portion of the data processing on the input data at data acquisition device 110. Rather than send raw input data to cloud server 150, in one embodiment data acquisition device 110 performs a portion of the data processing. For example, data acquisition device 110 may render sound, depth information, or an image before the data is sent to cloud server 150. In one embodiment, the amount of processing performed at data acquisition device 110 is based at least in part on the characteristics of data acquisition device 110 including, but not limited to: whether data acquisition device 110 has an integrated graphics processing unit, the amount of bandwidth available, the type processing power of data acquisition device 110, the battery power, etc. In some embodiments, operation 430 is performed every time data acquisition device 110 acquires data (e.g., operations 410 and/or 420), as shown by lines 431A and 431B of FIG. 4B as an example. In other embodiments, operation 430 is not performed every time data is acquired.

In operation 440, data acquisition device 110 streams input data to cloud server 150 over network 120. As discussed above, at least a portion of data streaming to cloud server 150 occurs concurrent to the capturing of input data, and concurrent to cloud server 150 performing data processing on the input data to generate processed data. Unlike transactional services, data acquisition device 110 continuously streams data to cloud server 150, and cloud server 150 continuously performs operations on the data and continuously sends data back to data acquisition device 110. While all these operations need not happen concurrently, at least a portion of these operations occur concurrently. In the case that not enough data was captured initially, additional data may be streamed to cloud server 150. In some embodiments, operation 440 is performed after initial input data is acquired by data acquisition device 110 in operation 410, as shown by line 441 of FIG. 4B as an example.

In operation 450, in one embodiment, data acquisition device 110 streams additional input data to cloud server 150 for cloud server 150 to reprocess the input data in combination with the additional input data in order to generate reprocessed data. In some instances the data captured by data acquisition device 110 may be unreliable, or cloud server 150 may indicate that it is uncertain as to the reliability of the input data. Thus, data acquisition device 110 continuously captures data, including additional data if cloud server 150 indicates additional data is required, such that cloud server 150 can reprocess the original input data with the additional data in order to develop reliable reprocessed data. In the case of a three-dimensional rendering cloud server 150 will incorporate the originally captured data with the additional data to develop a clearer, more certain and reliable rendering of three-dimensional object 140. In some embodiments, operation 450 is performed after additional input data is acquired by data acquisition device 110 in operation 420, as shown by line 451 of FIG. 4B as an example.

In operation 460, data acquisition device 110 receives processed data from cloud server 150, in which at least a portion of the processed data is received by data acquisition device 110 concurrent to the input data being streamed to cloud server 150. In addition to data acquisition device 110 continuing to capture data and cloud server 150 continuing to process data, data acquisition device 110 will receive processed data streamed from cloud server 150. This way, user 130 capturing data will know what data is of high quality and user 130 knows whether cloud server 150 needs more data without stopping the capturing of data. This process is interactive since the receipt of processed data indicates to user 130 where or what needs more data concurrent to the capturing of data by user 130. In some embodiments, operation 460 is performed after initial input data is streamed to cloud server 150 in operation 440, as shown by line 461 of FIG. 4B as an example.

In operation 470, in one embodiment, data acquisition device 110 receives reprocessed data. When additional data is captured and reprocessed by cloud server 150, the reprocessed data is sent back to data acquisition device 110. In some embodiments, data acquisition device 110 may indicate that even more additional data is needed in which case the process starts again, and additional data is captured, streamed to cloud server 150, processed, and sent back to data acquisition device 110. In some embodiments, operation 470 is performed after additional input data is streamed to cloud server 150 as in operation 450, as shown by line 471 of FIG. 4B as an example.

In operation 480, in one embodiment, data acquisition device 110 receives meta data (e.g., a quality indicator) that indicates that at least a portion of the processed data requires additional input data. In some embodiments that have a graphical user interface, the quality indicator may appear on the display as a color overlay, or some other form of highlighting a low quality area 210. As data acquisition device 110 captures additional data to fix low quality area 210, reprocessing is continuously performed at cloud server 150 and reprocessed data is continuously streamed to data acquisition device 110. It should be noted that not all data acquisition devices 110 include graphical user interfaces. In some embodiments sound, vibration, or other techniques may be employed to indicate low quality area 210. In some embodiments, operation 480 is performed any time data is received from cloud server 150. This may occur, for example, after operations 460 or 470, as shown by lines 481A and 481B in FIG. 4B.

In operation 490, in one embodiment, data acquisition device 110 indicates whether more input data is required. If more input data is required, user 130 may gather more input data. For example, if user 130 is attempting to perform a three-dimensional capture of object 140 and data acquisition device 110 indicates that more input data is required to perform the three-dimensional rendering, user 130 may have to move closer to object 140 in order to capture additional input data.

In operation 495, in one embodiment, data acquisition device 110 indicates that data acquisition device 110 has captured a sufficient amount of data and/or that no additional data is required. In one embodiment, data acquisition device 110 will automatically stop capturing data. In another embodiment, data acquisition device 110 must be shut off manually.

### Example Methods of Use

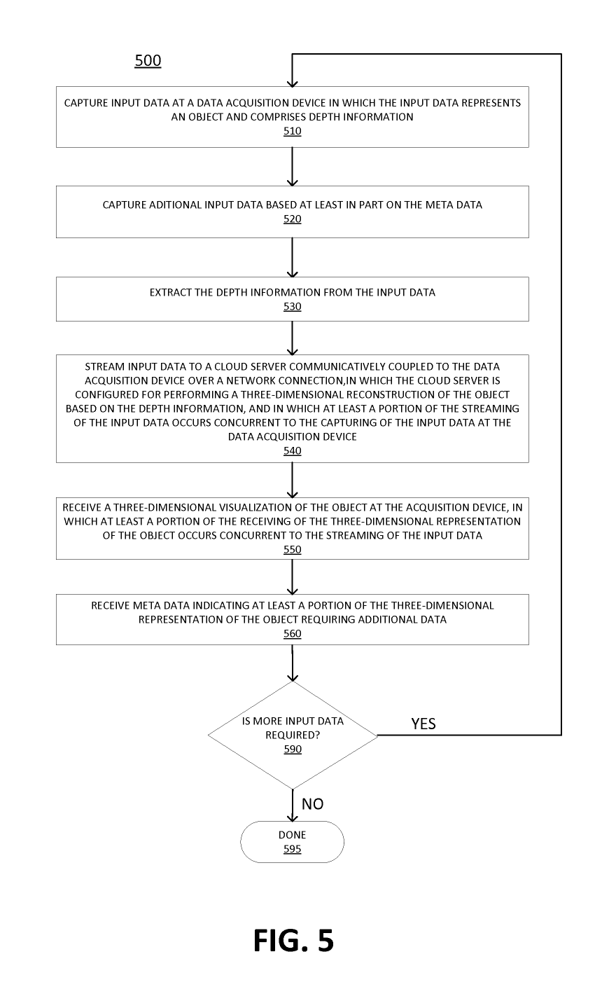

FIG. 5 illustrates example procedures used by various embodiments. Flow diagram 500 includes some procedures that, in various embodiments, are carried out by one or more of the electronic devices illustrated in FIG. 1, FIG. 2, FIG. 3, or a processor under the control of computer-readable and computer-executable instructions. In this fashion, procedures described herein and in conjunction with flow diagram 500 are or may be implemented using a computer, in various embodiments. The computer-readable and computer-executable instructions can reside in any tangible computer readable storage media, such as, for example, in data storage features such as RAM 308, ROM 310, and/or storage device 312 (all of FIG. 3). The computer-readable and computer-executable instructions, which reside on tangible computer readable storage media, are used to control or operate in conjunction with, for example, one or some combination of processor 306A, or other similar processor(s) 306B and 306C. Although specific procedures are disclosed in flow diagram 500, such procedures are examples. That is, embodiments are well suited to performing various other procedures or variations of the procedures recited in flow diagram 500. Likewise, in some embodiments, the procedures in flow diagram 500 may be performed in an order different than presented and/or not all of the procedures described in one or more of these flow diagrams may be performed, and/or one or more additional operations may be added. It is further appreciated that procedures described in flow diagram 500 may be implemented in hardware, or a combination of hardware, with either or both of firmware and software.

FIG. 5 is a flow diagram of a method for rendering a three-dimensional object.

In operation 510, data acquisition device 110 captures input data in which the input data represents object 140 and comprises depth information. In some embodiments, the input data may comprise image data and depth information associated with the image data. In one example, user 130 may move around object 140 while data acquisition device 110 captures depth and/or image information. With the depth information, a three-dimensional rendering can be created.

In operation 520, in one embodiment, data acquisition device 110 captures additional input data based at least in part on the meta data received by data acquisition device 110. Meta data may include a quality indicator which identifies areas which may benefit from higher quality input data. As discussed herein, the meta data may be shown on a display on data acquisition device 110, or on a third party display, as overlapping colors, symbols, or other indicators in order to indicate that additional input information is to be captured.

In operation 530, in one embodiment, data acquisition device 110 extracts the depth information from the input data. In one example, image data, depth data, and any other types of data are separated by data acquisition device 110 before streaming data to cloud server 150. In other embodiments, raw input data is streamed to cloud server 150.

In operation 540, data acquisition device 110 streams input data to cloud server 150 through network 120, wherein cloud server 150 is configured for performing a three-dimensional reconstruction of object 140 based on the depth information and/or image data, and wherein at least a portion of the streaming of the input data occurs concurrent to the capturing of the input data. As discussed above, at least a portion of data streaming to cloud server 150 occurs concurrent to the capturing of input data, and concurrent to cloud server 150 performing data processing on the input data to generate processed data. Unlike transactional services, data acquisition device 110 continuously streams data to cloud server 150, and cloud server 150 continuously performs operations on the data and continuously sends data back to data acquisition device 110. While all these operations need not occur concurrently, at least a portion of these operations occur concurrently.

In operation 550, data acquisition device 110 receives a three-dimensional visualization of object 140 wherein at least a portion of the receiving of the three-dimensional visualization of object 140 occurs concurrent to the streaming of the input data. In addition to data acquisition device 110 continuing to capture data and cloud server 150 continuing to process data, data acquisition device 110 will receive processed data streamed from cloud server 150. In one embodiment, a resulting three-dimensional model with meta data is streamed back to data acquisition device 110. This way, user 130 capturing data will know what data is of high quality and knows what areas of object 140 require more data without stopping the capturing of data. This process is interactive since the receipt of processed data indicates to user 130 where or what needs more data as user 130 is capturing data. In one example, a three-dimensional visualization of object 140 comprises a three-dimensional model of object 140 and meta data.

In operation 560, in one embodiment, data acquisition device 110 receives meta data (e.g., a quality indicator) which indicates that at least a portion of the three-dimensional visualization of object 140 requires additional data. In some embodiments that have a graphical user interface, the quality indicator may appear on the display as a color overlay, or some other form of highlighting a low quality area 210. As data acquisition device 110 captures additional data to improve low quality area 210, reprocessing is continuously performed at cloud server 150 and reprocessed data is continuously sent to data acquisition device 110.

In operation 590, in one embodiment, data acquisition device 110 indicates whether more input data is required. If more input data is required, user 130 is directed to capture more data with data acquisition device 110. For example, if user 130 is attempting to capture a three-dimensional representation of object 140 and data acquisition device 110 indicates that more input data is required, user 130 may need to capture data from another angle or move closer to object 140 to capture additional input data. In one example, a user may not be directed to capture more data. In one example, user 130 views the received representation from cloud server 150 and captures additional data.

In operation 595, in one embodiment, data acquisition device 110 indicates that a sufficient amount of data has been captured to perform a three-dimensional visualization of object 140. In one embodiment, data acquisition device 110 will automatically stop capturing data. In another embodiment, data acquisition device 110 must be shut off manually.

Embodiments of the present technology are thus described. While the present technology has been described in particular embodiments, it should be appreciated that the present technology should not be construed as limited by such embodiments, but rather construed according to the following claims.

What is claimed is:

1. A method for cloud-based data processing, said method comprising:
capturing input data at a data acquisition device;
streaming said input data to a cloud server communicatively coupled to said data acquisition device over a network connection, wherein at least a portion of said streaming said input data occurs concurrent to said capturing said input data, and wherein said cloud server is configured for performing data processing on said input data to generate processed data.

2. The method of claim 1 further comprising:
receiving said processed data at said data acquisition device, wherein at least a portion of said receiving said processed data occurs concurrent to said streaming said input data.

3. The method of claim 1 further comprising:
performing a portion of said data processing on said input data at said data acquisition device prior to said streaming said input data.

4. The method of claim 1 further comprising:
capturing additional input data; and
streaming said additional input data to said cloud server for said cloud server to reprocess said input data with said additional input data to generate reprocessed data; and
receiving said reprocessed data at said data acquisition device.

5. The method of claim 1 further comprising:
receiving at said data acquisition device meta data indicating that at least a portion of said processed data requires additional input data.

6. The method of claim 4 wherein said meta data guides a user to capture additional data.

7. The method of claim 1 wherein said processed data is based on said input data streamed to said cloud server by said data acquisition device and additional input data streamed to said cloud server by a another data acquisition device.

8. A computer-usable storage medium having instructions embodied therein that when executed cause a computer system to perform a method for rendering a three-dimensional object, said method comprising:
capturing input data at a data acquisition device, said input data representing an object and comprising depth information;
streaming said input data to a cloud server communicatively coupled to said data acquisition device over a network connection, wherein said cloud server is configured for performing a three-dimensional reconstruction of said object based on said depth information, and wherein at least a portion of said streaming said input data occurs concurrent to said capturing said input data at said data acquisition device; and
receiving a three-dimensional representation of said object at said data acquisition device, wherein at least a portion of said receiving said three-dimensional representation of said object occurs concurrent to said streaming said input data.

9. The computer-usable storage medium of claim 8 wherein said method further comprises:
extracting said depth information from said input data, wherein said extracting is performed prior to said streaming said input data; and
streaming said depth information to said cloud server.

10. The computer-usable storage medium of claim 8 wherein said capturing said input data, said streaming said input data, and said receiving said three-dimensional representation of said object occur concurrently, such that a quality of said three-dimensional representation of said object is increased as said input data is streamed to said cloud server.

11. The computer-usable storage medium of claim 8 wherein said method further comprises:
receiving meta data indicating at least a portion of said three-dimensional representation of said object requiring additional input data.

12. The computer-usable storage medium of claim 11 wherein said method further comprises:
capturing additional input data based at least in part on said meta data.

13. An apparatus comprising:
an optical capturing component for capturing input data, said input data representing an object and comprising depth information;
a transmitter for streaming said input data to a cloud server communicatively coupled to said apparatus over a network connection, wherein said cloud server is configured for performing a three-dimensional reconstruction of said object based on said input data and said depth information, and wherein at least a portion of said streaming said input data occurs concurrent to said capturing said data; and
a receiver for receiving a three-dimensional representation of said object at said apparatus, wherein at least a portion of said receiving said three-dimensional representation of said object occurs concurrent to said streaming said input data;
a memory for storing said input data and said three-dimensional representation;
a processor for coordinating said capturing of said input data, said streaming said input data, and said receiving said three-dimensional representation; and
a display for receiving meta data indicating at least a portion of said three-dimensional representation of said object requiring additional input data.

14. The apparatus of claim 13 wherein said memory is configured to perform a depth image extraction that is then uploaded to said cloud server.

15. The apparatus of claim 13 wherein said processor performs part of said three-dimensional reconstruction.
